(19) United States
(12) Patent Application Publication
(10) Pub. No.: US 2024/0306523 A1
(43) Pub. Date: Sep. 19, 2024

(54) Roller Ring for a Roller Body of a Soil-Tillage Device

(71) Applicant: LEMKEN GmbH & Co. KG, Alpen (DE)

(72) Inventor: Christoph HAPPE, Alpen (DE)

(73) Assignee: LEMKEN GmbH & Co. KG, Alpen (DE)

(21) Appl. No.: 18/272,484

(22) PCT Filed: Jan. 17, 2022
(86) PCT No.: PCT/DE2022/100040

§ 371 Date: Jul. 14, 2023

(30) Foreign Application Priority Data
Jan. 19, 2021 (DE) 10 2021 101 021.7

(51) Int. Cl. A01B 29/04

(52) U.S. Cl. CPC A01B 29/041

(57) ABSTRACT

A roller ring (8) for a roller (3,4) of a soil-tillage apparatus (1) comprises two rotationally symmetrical body halves (9) arranged opposite one another. Each body half (9) has a flange-shaped profile portion (10) extending in the radial direction (R), against which the body halves (9) abut over the entire surface. At least one profile portion (10) is divided into an inner contact portion (12) as well as an adjoining outer edge portion (13). The body halves (9) are at least partially connected by means of a substance-to-substance bond (15) radially on the inner side of the contact portion (12).

### CROSS-REFERENCE TO RELATED APPLICATIONS

This application is a national stage application, filed under 35 U.S.C. § 371, of International Patent Application PCT/DE2022/100040, filed on Jan. 17, 2022, which claims the benefit of German Patent Application DE 10 2021 101 021.7, filed on Jan. 19, 2021.

### TECHNICAL FIELD

The present disclosure relates to a roller ring for a roller body of a soil-tillage device. The disclosure furthermore relates to a roller body for a soil-tillage apparatus as well as to a method for producing a roller ring for a roller body of a soil-tillage apparatus.

### BACKGROUND

A roller ring is known from DE 103 31 233 A1. The roller ring comprises two body halves, which are embodied as pressed cam segments, and which are welded together. Each body half has a flange-shaped profile portion, which extends in a radial direction, in the form of an outer edge portion, on which the body halves abut against one another over the entire surface. The outer edge portions as well as the radial front surfaces thereof are embodied in a cured manner in order to increase the wear resistance. The body halves embodied as cam segments are alternately welded to one another on the outer edge portion by means of a plug weld.

A roller ring is furthermore also known from WO 03/086043 A1. The roller ring comprises two body halves, which each have a profile portion in the shape of a ring-shaped flange, on which the body halves abut against one another. The two body halves are connected to one another by welding the ring-shaped flanges.

During the soil tillage, soil-tillage apparatuses equipped with rollers are used for crumbling and reconsolidation of the soil to be tilled. The shape of the roller makes it possible to influence the intensity of the crumbling and the depth of the reconsolidated zone thereby. In particular closed roller rings have proven themselves here under sticky or stony conditions. In the case of the roller rings known from the prior art, the body halves of which are connected to one another by means of welding, hardness losses occur in the wear-intensive zone in the case of plug welds as well as in the case of a circumferential weld seam. In the case of an only punctiform connection of the two body halves, incoming liquid can make the varnishing process more difficult and can lead to unwanted corrosion.

### SUMMARY

The disclosure is thus based on the object of further developing a roller ring of the above-mentioned type as well as a method for producing a roller ring, whereby the disadvantages of the prior art are avoided, in particular to minimize the thermal influence on the microstructure of the material, of which the two body halves consist.

In terms of the device, this object is solved by means of a roller ring as disclosed herein. In terms of the method, this object is furthermore solved by means of a method as disclosed herein.

A roller ring for a roller body of a soil-tillage apparatus is proposed, wherein the roller ring comprises two rotationally symmetrical body halves arranged opposite one another, wherein each body half has a flange-shaped profile portion extending in the radial direction, against which the body halves abut over the entire surface. At least one profile portion is divided into an inner contact portion as well as an adjoining outer edge portion, wherein the body halves are at least partially connected by means of a substance-to-substance bond radially on the inner side of the contact portion. At least one profile portion is thus divided into a wear zone, the outer edge portion in which the original strength of the base material is maintained, and into a connecting zone, the inner contact portion, which is available for the connection of the two body halves. The edge portions are in particular embodied in a cured manner. A distance, which at least reduces disadvantageous thermal influences on the microstructure of the edge portions in the case of a substance-to-substance bond is created between the inner contact portions, which serve the purpose of the substance-to-substance bond, and the outer edge portions.

It is advantageous when the radial extension of at least one contact portion is between 20% and 40% of the radial extension of the profile portion. Particularly preferably, the radial extension of at least one contact portion is between 25% and 33% of the radial extension of the profile portion. A contact portion can thereby be arranged radially on the inner side in the profile portion, in particular on the side of the hollow space. The substance-to-substance bond can thereby be created at a largest possible distance from the outer edge portions and the radial front surfaces thereof, whereby the influence on the strength of the, in particular cured, outer edge portions is small.

The substance-to-substance bond can preferably be embodied to be completely circumferential in the circumferential direction. The tightness of internal regions of the body halves, which form a hollow space, can be ensured thereby.

According to a preferred embodiment, the substance-to-substance bond can be capable of being established by means of one- or two-sided melt-on or fusion.

For this purpose, openings, which are arranged essentially equidistantly, can be arranged in the contact portion of at least one body half so as to be distributed in the circumferential direction. A melt-on or fusion can take place on one side as well as on both sides through the openings. Melt-on can thus take place, for example, on the foot of an opening.

The openings can preferably have a round, oval, or slot-shaped contour.

According to a preferred embodiment, the substance-to-substance bond can be capable of being established by means of one- or two-sided alternatingly intermittent melt-on or fusion. This can preferably take place by means of laser welding or plasma welding.

The body halves can in particular be embodied as common parts. This has the advantage of a simpler and more cost-efficient production of the body halves. The body halves can be produced in particular by means of a hot forming process. The openings in the contact portion of at least one body half can be produced, for example, by means of punching.

It is advantageous when the openings in the contact portions of both body halves are arranged on a pitch circle with identical radius. For this purpose, the openings can in particular be embodied as elongated holes or as annular portions. In the case of an embodiment of the openings as elongated holes or as annular portions, the respective portion length of which in the circumferential direction is smaller than the portion length of the closed regions between the portions, a reliable substance-to-substance bond between the body halves can be attained between them by means of a rotation of the body halves, which are embodied as common parts, about an angle due to an intermittent arrangement.

The openings can furthermore be alternately arranged with identical pitch oppositely in the contact portions. A maximum length of the openings formed as elongated holes or as annular portions is determined from the product of circular number and pitch radius, divided by the number of openings in the contact portion of the body half.

The body halves, which are embodied as common parts, can thus be arranged offset from one another by half a pitch. It can be attained thereby that an overlapping of the openings, in particular of the openings embodied as elongated holes or as annular portions, is avoided. The annular portions, which are connected by means of a substance-to-substance bond on both sides in the circumferential direction can nonetheless form an essentially continuous substance-to-substance bond in this way.

According to a further development, the body halves can have different radial extensions of the profile portions. One body half can in particular have a shortened edge portion, which does not extend all the way to the radial front surface of the body half arranged oppositely. In the case of this embodiment, the radial front surface of the shortened profile portion can serve the purpose of connecting this body half by means of a substance-to-substance bond to the contact portion of the opposite body half.

The profile portions of the body halves can preferably be provided with a radial and/or axial profiling. For this purpose, the respective profile portion can be embodied, for example, in an essentially jagged or waved manner. The profiling has to be chosen in such a way thereby that intermediate segments are present, which provide for a substance-to-substance bond.

The at least partial substance-to-substance bond can preferably be capable of being produced by means of laser welding, resistance seam welding, or mash seam welding. In particular the laser welding as well as the resistance seam welding provide for an interval-like or continuous welding of the two body halves by means of melt-on or fusion.

Alternatively, the at least partial substance-to-substance bond can be capable of being produced by means of the introduction of an admixture at least between the contact portions. This is advantageous in particular when the profile portions of the body halves are provided with a radial profiling.

The admixture can be an adhesive or a hard solder thereby. These admixtures can lead to a substance-to-substance bond between the contact portions only by means of a thermal treatment.

The above object is furthermore solved by means of a method for producing a roller ring for a roller body of a soil-tillage apparatus.

A method for producing a roller ring for a roller body of a soil-tillage apparatus is proposed, wherein the roller ring is made of two rotationally symmetrical body halves, which are arranged opposite one another, wherein each body half has a profile portion extending in the radial direction, on which the body halves are placed against one another over the entire surface, wherein at least one of the profile portions is produced so as to be divided into an inner contact portion as well as an adjoining outer edge portion, wherein the body halves are at least partially connected by means of a substance-to-substance bond radially on the inner side of the contact portion. Reference may be made to all embodiments relating to the roller ring as proposed.

The substance-to-substance bond can in particular be created by means of one- or two-sided melt-on or fusion.

The substance-to-substance bond can particularly preferably be created by means of, in particular alternately intermittent, one- or two-sided melt-on or fusion.

Alternatively, the substance-to-substance bond can be created by means of the introduction of an admixture at least between the contact surfaces of the profile portions. Hard solder or an adhesive, which can in particular be thermally activated, can be used as admixture.

According to a preferred further development, the body halves can be produced by means of hot forming, wherein, after the hot forming and in particular a curing, the admixture is introduced and is subjected to a heat treatment, wherein at least the edge portion can subsequently in particular be tempered. The impact strength can be increased thereby, whereby a good resilience, in particular a lower impact sensitivity of the outer edge portion against rocks, as well as a longer tightness can be ensured with increasing wear of the edge portion, and the risk of a brittle fracture can be reduced.

It is advantageous when the heat treatment of the admixture can be effected by means of tempering. The separate method step of the heat treatment for hard soldering or activating the adhesive can be saved in this way after the curing. The energy input required for the hard soldering or activation of the adhesive can furthermore be reduced.

### BRIEF DESCRIPTION OF THE DRAWINGS

The present invention will be described in more detail below on the basis of exemplary embodiments, which are illustrated in the drawings, in which:

FIG. 1 shows a perspective illustration of a soil-tillage apparatus;

FIG. 2 shows a perspective illustration of a roller ring;

FIG. 3 shows a partial illustration of the roller ring according to FIG. 1 in sectional view;

FIG. 4 shows a partial illustration of the roller ring according to FIG. 1 according to a further embodiment;

FIG. 5 shows a frontal view onto a body half of the roller ring according to FIG. 4 with one-sided arrangement of openings;

FIG. 6 shows a frontal view onto a body half of the roller ring according to a further embodiment with two-sided arrangement of openings;

FIG. 7 shows a frontal view onto a body half of the roller ring, which is produced by means of resistance seam welding using continuous current;

FIG. 8 shows a frontal view onto a body half of the roller ring, which is produced by means of resistance seam welding using periodically switched welding current;

FIG. 9A/B shows a frontal view as well as a partial illustration of the roller ring according to a further embodiment; and

FIG. 10 shows a partial illustration of the roller ring according to a further embodiment, in the case of which an admixture is introduced between internal contact portions of the body halves.

### DETAILED DESCRIPTION

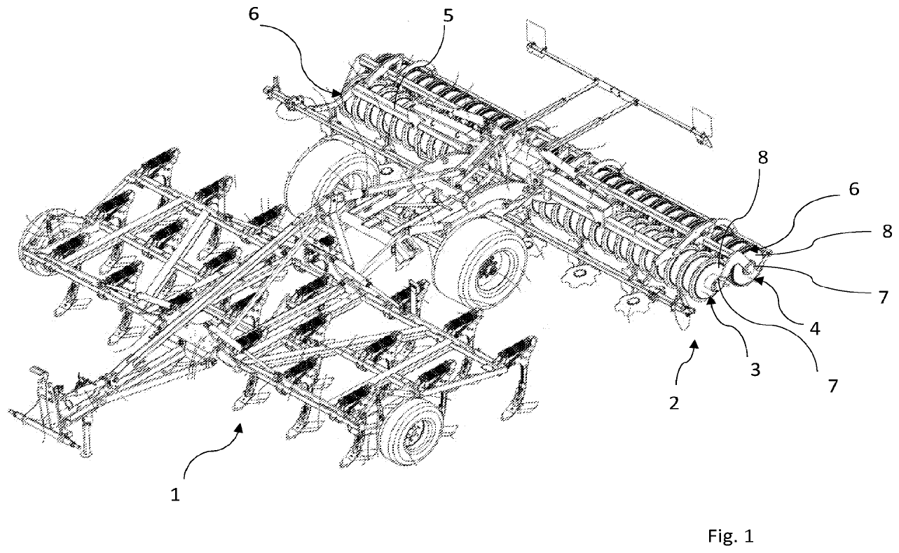

A perspective illustration of a soil-tillage apparatus 1 is illustrated in an exemplary manner in FIG. 1. Soil loosening tools are arranged in the front region of the soil-tillage apparatus 1. The soil-tillage apparatus 1 comprises a reconsolidation means 2, which is arranged in the region downstream from the soil loosening tools. In the illustrated exemplary embodiment, the reconsolidation means 2 consists of a front and a rear pair of rollers 3, 4, wherein each roller 3, 4 extends over half the machine width of the soil-tillage apparatus 1. The rollers 3, 4 are in each case rotatably mounted in a roller frame 5. The arrangement of the rollers 3, 4 is formed mirror-symmetrically here. An individual roller row as lateral roller pair is also possible, the large variety of roller shapes are likewise also conceivable as tire packers, which, in turn, can also serve for the road transport of the soil-tillage apparatus 1. The reconsolidation means 2 compacts the loosened soil over the entire surface. However, a strip-wise reconsolidation is also conceivable. The reconsolidation means 2 is embodied in a multiple mobile manner in several degrees of freedom but can also be embodied to be rigid.

The rollers 3, 4 are embodied with a roller body 6, wherein the roller body 6 comprises several closed roller rings 8, which are arranged on an axis 7, which is rotatably mounted in the roller frame 5.

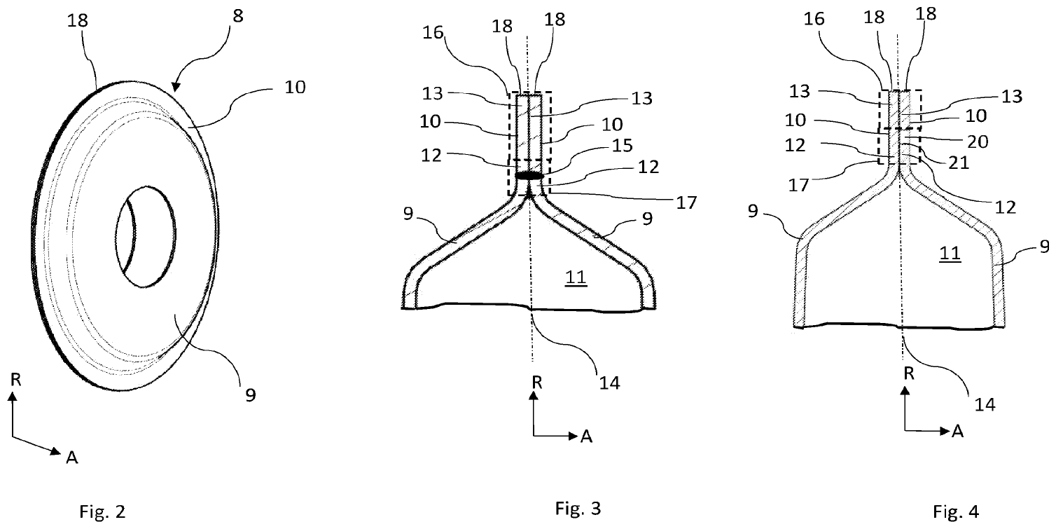

A perspective illustration of a roller ring 8 is illustrated in FIG. 2. The roller ring 8 comprises two rotationally symmetrical body halves 9, which are arranged opposite one another, only one of which is visible in FIG. 2. Each body half 9 has a flange-shaped profile portion 10, which extends in the radial direction R.

FIG. 3 shows a partial illustration of the roller ring 8 according to FIG. 1 in sectional view. In the joined state, a closed hollow space 11 forms between the rotationally symmetrical body halves 9. The respective body half 9 has an essentially plate-shaped contour. Each body half 9 has a flange-shaped profile portion 10, which extends in the radial direction R and on which the body halves 9 abut against one another over the entire surface. The region of the body halves 9 below the profile portions 10 extends in the opposite direction in the axial direction A, whereby the hollow space 11 is formed. 14 identifies an axis of symmetry of the roller ring 8 or of the body halves 9, respectively.

At least one profile portion 10 is divided into an inner contact portion 12 as well as an adjoining outer edge portion 13, viewed in the radial direction R. Here and preferably, both profile portions 10 are divided into the inner contact portion 12 and the adjoining outer edge portion 13. At least one profile portion 10 is thus divided into a wear zone 16, the outer edge portion 13 in which the original strength of the base material is maintained, and into a connecting zone 17, the inner contact portion 12, which is available for the connection of the two body halves 9.

The body halves 9 are at least partially connected by means of a substance-to-substance bond radially on the inner side of the contact portion 12. For this purpose, a substance-to-substance bond 15 can be established between the two body halves 9 by means of one- or two-sided melt-on or fusion, which can be performed, for example, by means of laser welding. In the illustrated exemplary embodiment, the substance-to-substance bond 15 is embodied as a continuous, circumferential weld seam radially on the inner side of the contact portions 12. The at least partial substance-to-substance bond can furthermore be capable of being established by means of resistance seam welding or mash seam welding.

The radial extension of at least one contact portion 12 is between 20% and 40% of the radial extension of the profile portion 10. The radial extension of at least one contact portion 12 is particularly preferably between 25% and 33% of the radial extension of the profile portion 10. The contact portion 12 is thereby arranged radially on the inner side in the profile portion 10. The substance-to-substance bond 15 can thereby be created at a largest possible distance from the outer edge portions 13 and the radial front surfaces 18 thereof, whereby the influence on the strength of the, in particular cured, outer edge portions 13 is low.

A partial illustration of the roller ring 8 according to FIG. 1 is shown in FIG. 4 according to a further embodiment. At least one body half 9 thereby has several openings 20, which are arranged so as to be distributed in the circumferential direction, in the contact portion 12. The openings 20 are embodied identically and are preferably arranged equidistantly within the connecting zone 17. The respective openings 20 can be embodied with different geometries. The openings 20 can have, for example, a round, oval, or slot-shaped contour. In the case of this embodiment, the substance-to-substance bond 15 is achieved by means of melting onto the foot 21 on the inner side of the openings 20, i.e. in the largest possible distance from the wear zone 16 in the radial direction R. An auxiliary welding material can preferably be added, which at least partially fills the openings 20, preferably in a flush manner.

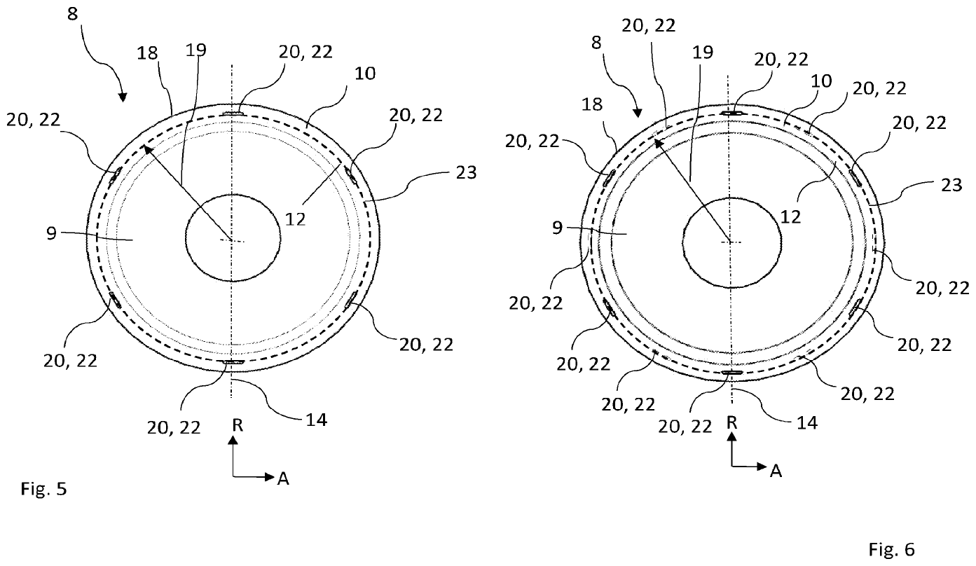

FIG. 5 shows an illustration of a frontal view onto a body half 9 of the roller ring 8 according to FIG. 4. According to this embodiment, a plurality of openings 20 are provided only within the contact portion 12, which is illustrated so as to be visible in the foreground. The openings 20 are preferably embodied as elongated holes 22 here. The arrangement of the elongated holes 22 is made to be symmetrical in the circumferential direction, lying on a pitch circle 23 and at the same distance from one another. The pitch circle 23 has a pitch radius 19. The partial substance-to-substance bonding radially on the inner side of the contact portion 12 takes place on one side from the body half 9, which contact portion 12 is embodied with the openings 20 or elongated holes 22, respectively.

A frontal view onto a body half 9 of the roller ring 8 according to a further embodiment with two-sided arrangement of openings 20 is illustrated in FIG. 6. The openings 20 are also embodied as elongated holes 22 here, wherein they are arranged in both contact portions 12. For this purpose, the openings 20 of the rearward body half 9 facing away from the visible image plane, are suggested in a dashed manner. The embodiment of the body halves 9 as common parts makes it possible to create an offset between the openings 20, which are arranged on a common pitch circle 23, by rotating the two body halves 9, which abut against one another, about an angle in the circumferential direction. As in the case of the embodiment according to FIG. 4, which has already been described, the at least partial substance-to-substance bonding radially on the inner side of the contact portion 12 takes place thereby by means of melting onto the foot 21 on the inner side of the openings 20, wherein the welding process is performed alternately here from both sides of the roller ring 8. By means of the embodiment of the body halves 9 as common parts and the offset of the position of the openings 20 to one another by means of rotating, the number of the substance-to-substance bonds 15 is doubled.

It is advantageous when the openings 20 in the contact portions 12 of the both body halves 9 are arranged on a pitch circle 23 with identical pitch radius 19. As already specified, the openings 20 can be embodied for this purpose as elongated holes 22 or as annular portions. In the case of the embodiment of the openings 20 as elongated holes 22 or as annular portions, the respective portion length of which in the circumferential direction is smaller than or equal to one of the closed regions between elongated holes 22, a reliable substance-to-substance bond can be attained between the body halves 9, which are embodied as common parts, by means of a rotation thereof about an angle.

The openings 20 can thereby be alternately arranged oppositely in the contact portions with identical pitch. A maximum length of the openings 20, which are formed as elongated holes 22 or as annular portions, is determined from the product of circular number and pitch radius 19, divided by the number of openings 20 in the contact portion 12 of the body half 9.

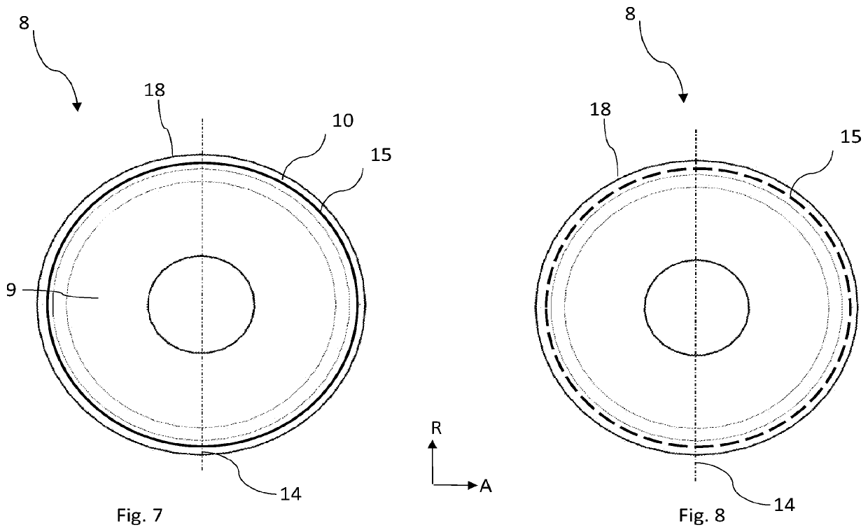

The illustration in FIG. 7 shows a frontal view onto a body half 9 of the roller ring 8, which is produced by means of resistance seam welding using continuous current as welding current. A frontal view onto a body half 9 of the roller ring 8, which is produced by means of resistance seam welding using periodically switched welding current, is shown in FIG. 8. During the substance-to-substance bonding on the inner side by means of resistance seam welding using continuous current, a weld seam, which is continuous in the circumferential direction, is created as substance-to-substance bond on the inner side of the contact portions 12. During the resistance seam welding, in contrast, an intermittent weld seam is created as substance-to-substance bond, which provides the advantage of a reduced heat input, on the inner side of the contact portions 12 using periodically switched welding current. Instead of an intermittent roll welding process, a resistance welding with punctiform or elongated welding current electrodes can also take place. The electrode contour or the contact surface thereof to the workpiece, respectively, thereby falls below the expansion of the contact portions 12 in the radial direction thereof in order to decrease a heat input.

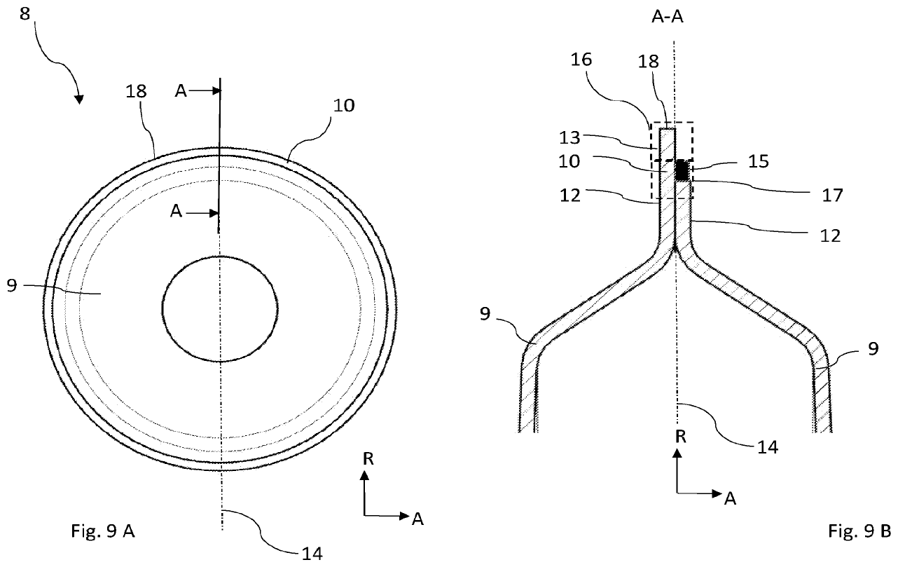

FIG. 9A/B show a frontal view as well as a partial illustration of the roller ring 8 in sectional view along the line A-A according to a further embodiment. According to this further development, the body halves 9 can have different radial extensions of the profile portions 10. One body half 9 can in particular have a shortened edge portion 13, which does not extend all the way to the radial front surface 18 of the oppositely arranged body half 9. In the case of this embodiment, the radial front surface 18 of the shortened profile portion 10 can serve the purpose of connecting this body half 9 by means of a substance-to-substance bond to the contact portion 12 of the opposite body half 9.

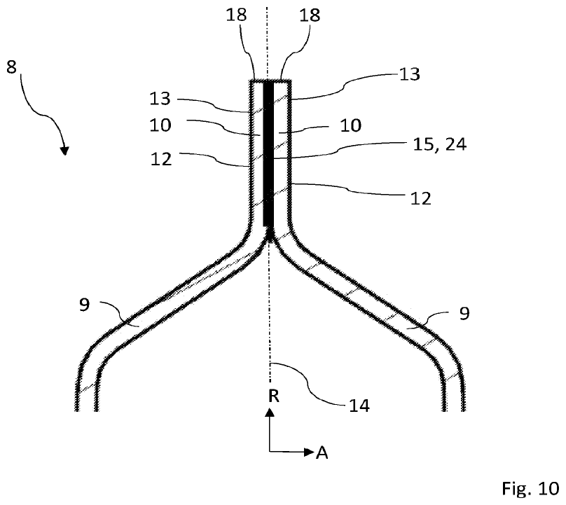

FIG. 10 is a partial illustration of the roller ring 8 according to a further embodiment, in the case of which an admixture 24 is introduced at least between the internal contact portions 12 of the body halves 9. The admixture 24 can preferably also be located between the edge portions 13 of the profile portions 10. The admixture 24 can be embodied as adhesive or hard solder.

The body halves 9 are preferably produced by means of hot forming. According to the embodiment according to FIG. 10, the admixture 24 is introduced after the hot forming and in particular the curing and is subjected to a heat treatment. The heat treatment can serve to activate the adhesive or alternatively the hard soldering. At least the edge portions 13 can be tempered subsequently. The impact strength can be increased thereby, whereby a good resilience, in particular a lower impact sensitivity of the outer edge portion 13 against rocks, as well as a longer tightness of the hollow space 11 can be ensured with increasing wear of the edge portion 13, and the risk of a brittle fracture can be reduced.

It is advantageous when the heat treatment of the admixture 24 can also be effected directly by means of tempering. A separate method step of the heat treatment for hard soldering or activating the adhesive can be saved in this way after the curing. An adhesive activation can furthermore take place completely or partially as part of an anti-corrosion treatment, preferably a stoving or drying treatment.

### LIST OF REFERENCE NUMERALS

1 soil-tillage apparatus
2 reconsolidation means
3 roller
4 roller
5 roller frame
6 roller body
7 axis
8 roller ring
9 body half
10 profile portion
11 hollow space
12 contact portion
13 edge portion
14 axis of symmetry
15 substance-to-substance bond
16 wear zone
17 connecting zone
18 radial front surface
19 pitch radius
20 opening
21 foot
22 elongated hole
23 pitch circle
24 admixture
A axial direction
R radial direction

1.-23. (canceled)

24. A roller ring (8) for a roller (3,4) of a soil-tillage apparatus (1), comprising:
two rotationally symmetrical body halves (9) arranged opposite one another,
wherein each body half (9) has a flange-shaped profile portion (10) extending in a radial direction (R),
wherein the body halves (9) abut along entire surfaces of their flange-shaped profile portions (10),
wherein at least one of the profile portions (10) is divided into an inner contact portion (12) and an adjoining outer edge portion (13),
wherein the body halves (9) are at least partially connected by a substance-to-substance bond (15) radially on an inner side of the contact portion (12).

25. The roller ring (8) according to claim 24,
wherein a radial extension of the inner contact portion (12) is between 20% and 40% of a radial extension of the profile portion (10).

26. The roller ring (8) according to claim 24,
wherein the substance-to-substance bond (15) is embodied to be completely circumferential in a circumferential direction of the body halves (9).

27. The roller ring (8) according to claim 24,
wherein the substance-to-substance bond (15) is established by one- or two-sided melt-on or fusion.

28. The roller ring (8) according to claim 27,
wherein openings (20, 22), which are arranged essentially equidistantly, are arranged in the contact portion (12) of at least one of the body halves (9) so as to be distributed in a circumferential direction.

29. The roller ring (8) according to claim 28,
wherein the openings (20, 22) have a round, oval, or slot-shaped contour.

30. The roller ring (8) according to claim 27,
wherein the substance-to-substance bond (15) is established by alternatingly intermittent melt-on or fusion.

31. The roller ring (8) according to claim 24, wherein the body halves (9) are embodied as common parts.

32. The roller ring (8) according to claim 28,
wherein the openings (20) in the contact portions (12) of the body halves (9) are arranged on a pitch circle (23) with identical pitch radius (19).

33. The roller ring (8) according to claim 32,
wherein the openings (20) are alternately arranged with identical pitch oppositely in the contact portions (12).

34. The roller ring (8) according to claim 33,
wherein the body halves (9) are arranged offset from one another by a pitch.

35. The roller ring (8) according to claim 28,
wherein the body halves (9) have different radial extensions of the profile portions (10).

36. The roller ring (8) according to claim 24,
wherein the profile portions (10) of the body halves (9) are provided with a radial and/or axial profiling.

37. The roller ring (8) according to claim 24,
wherein the substance-to-substance bond (15) is established by laser welding, plasma welding, electron beam welding, friction welding, resistance seam welding, or mash seam welding.

38. The roller ring (8) according to claim 24,
wherein the substance-to-substance bond (15) is established by introduction of an admixture (24) at least between the contact portions (12).

39. The roller ring (8) according to claim 38,
wherein the admixture (24) is an adhesive or a hard solder.

40. A soil-tillage apparatus (1), comprising
at least one roller (3, 4) comprising a roller body (6),
wherein the roller body (6) comprises several closed roller rings (8) according to claim 24 arranged on a rotatably mounted axis (7).

41. A method for producing a roller ring (8) for a roller body (6) of a soil-tillage apparatus (1), comprising:
arranging two rotationally symmetrical body halves (9) of the roller ring (8) opposite one another;
placing the body halves (9) against one another such that profile portions (10) extending in a radial direction of each body half (9) abut over their entire surfaces;
producing at least one of the profile portions (10) so as to be divided into an inner contact portion (12) as well as an adjoining outer edge portion (13); and
at least partially connecting the body halves (9) by a substance-to-substance bond radially on an inner side of the contact portion (12).

42. The method according to claim 41,
wherein the substance-to-substance bond is created by one- or two-sided melt-on or fusion.

43. The method according to claim 41,
wherein the substance-to-substance bond is created by alternately intermittent one- or two-sided melt-on or fusion.

44. The method according to claim 41,
wherein the substance-to-substance bond is created by introduction of an admixture (24) at least between the contact portions (12) of the profile portions (10).

45. The method according to claim 44,
wherein the body halves (9) are produced by hot forming and curing, and
wherein the admixture (24) is introduced after the hot forming and curing and is subjected to a heat treatment.

46. The method according to claim 45, wherein the heat treatment of the admixture (24) is effected by tempering.
